(19) United States
(12) Patent Application Publication
(10) Pub. No.: US 2020/0375427 A1
(43) Pub. Date: Dec. 3, 2020

(54) METHOD FOR A ROBOT CLEANER WITH AN ADAPTIVE CONTROL METHOD BASED ON THE MATERIAL OF THE FLOOR, AND A ROBOT CLEANER

(71) Applicant: Bot3, Inc., SANTA CLARA, CA (US)

(72) Inventor: CHI-MIN HUANG, SANTA CLARA, CA (US)

(21) Appl. No.: 16/426,495

(22) Filed: May 30, 2019

(51) Int. Cl. A47L 9/28; G06K 9/00; G06K 9/62; G05D 1/02; G05B 13/02

(52) U.S. Cl. CPC A47L 9/2826; A47L 9/2852; A47L 9/2842; G06K 9/00671; G05D 2201/0203; G05D 1/0221; G05B 13/027; A47L 2201/04; A47L 2201/06; G06K 9/6256

(57) ABSTRACT

The present invention discloses a robot cleaner, comprising: a receive module, configured to receive a first image information around said robot cleaner; a processor module, configured to identify a material of the floor around said robot cleaner, and a position of said first image information according to said first image information; a control module, configured to send a control signal to control movement of the robot cleaner according to the material of the floor which is identified by said processor module and the position of said first image information; and a motion module, configured to control operation of a motor to drive the robot cleaner with a cleaning mode according to said control signal.

### TECHNICAL FIELD

The present invention relates to robot cleaner control field, and in particular relates to a method for a robot cleaner with an adaptive control method based on the material of the floor and a robot cleaner.

### BACKGROUND

With the increasing popularity of smart devices, the mobile robots become common in various aspects, such as logistics, home care, etc. The traditional robot cleaner move in the room and clean the room. In present technology, when the user set up a cleaning mode of the robot cleaner, and the robot cleaner clean the room with same cleaning mode. For different material of the floor, the present robot cleaner cannot switch cleaning mode with the change of the material of the floor, and the cleaning effect is not good enough. For example, if the material of the floor is soft material, the robot cleaner need to clean with high intensity cleaning mode or repeat cleaning. On the contrary, if the material of the floor is hard material, the robot cleaner clean with low intensity cleaning mode is enough. However, the user should switch the cleaning mode manually when the material of the floor is different. Thus, it is quite necessary to develop a robot cleaner with an adaptive control method based on the material of the floor and a robot cleaner.

The present invention provides a robot cleaner with an adaptive control method based on the material of the floor and a robot cleaner by using deep learning, and provides user better service experience.

### SUMMARY

The present invention disclose a robot cleaner, comprising: a receive module, configured to receive a first image information around said robot cleaner; a processor module, configured to identify a material of the floor around said robot cleaner, and a position of said first image information according to said first image information; a control module, configured to send a control signal to control movement of the robot cleaner according to the material of the floor which is identified by said processor module and the position of said first image information; and a motion module, configured to control operation of a motor to drive the robot cleaner with a cleaning mode according to said control signal.

The present invention also provide an control method for a robot cleaner, comprising: sampling first image information around the robot cleaner; identifying a material of the floor around said robot cleaner, and a position of said first image information according to said first image information; sending a control signal to control movement of the robot cleaner according to the material of the floor which is identified and the position of said first image information; and moving with a cleaning mode according to the control signal.

Advantageously, in the present invention, the robot cleaner and control method thereof can provide better home service than traditional robot cleaner.

### BRIEF DESCRIPTION OF THE DRAWINGS

FIG. 1 illustrates a block diagram of a robot cleaner with an adaptive control method based on the material of the floor according to one embodiment of the present invention.

FIG. 2 illustrates a block diagram of a processor module in the robot cleaner with an adaptive control method based on the material of the floor according to one embodiment of the present invention.

FIG. 3 illustrates a flowchart of a control method for a robot cleaner with an adaptive control method based on the material of the floor.

FIG. 4 illustrates a flowchart of a method for identifying material around a robot cleaner with an adaptive control method based on the material of the floor.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The present disclosure is directed to providing a robot cleaner with an adaptive control method based on the material of the floor, and a robot cleaner. Embodiments of the present robot cleaner can clean the floor according to the material of the floor in combination with deep learning.

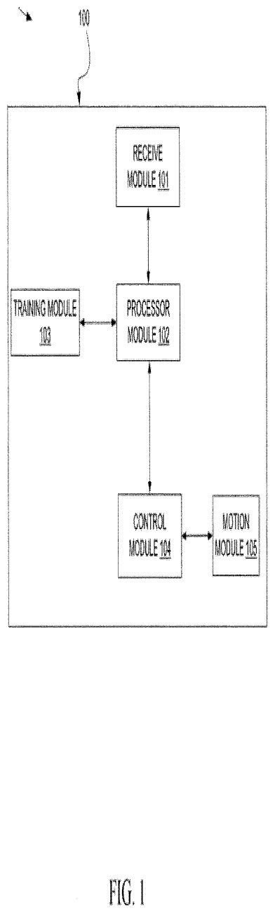

FIG. 1 illustrates a block diagram of a robot cleaner 100 with an adaptive control method based on the material of the floor according to one embodiment of the present invention. As shown in FIG. 1, the robot cleaner 100 includes a receive module 101, a processor module 102, a training module 103, a control module 104 and a motion module 105. Each module described herein can be implemented as logic, which can include a computing device (e.g., structure: hardware, non-transitory computer-readable medium, firmware) for performing the actions described. As another example, the logic may be implemented, for example, as an ASIC programmed to perform the actions described herein. According to alternate embodiments, the logic may be implemented as stored computer-executable instructions that are presented to a computer processor, as data that are temporarily stored in memory and then executed by the computer processor.

In one embodiment, the receive module 101 (e.g., a image collecting unit) which is located above the robot cleaner 100 can be configured to capture surrounding images (e.g., ahead image of the robot cleaner 100 or back image of the robot cleaner 100), is also called image information, which can be used for image deep learning database and original images, and is used to identify the material of the floor accordingly. The image collecting unit in the receive module 103 can be configured to include at least one camera, for example, include an ahead camera and a back camera. The training module 103 can be configured to train kinds of images of the material of the floor with lightweight deep neural network offline model training, and build a deep neural network model for identifying the material of the floor. Specifically, the training module 103 includes a database stored kinds of images of the floor, and builds a deep neural network model. The deep neural network model is used for deep learning by the robot cleaner 100 and identifying the material of the floor finally.

Specifically, for the special image database, for example: kinds of image of the floor, the training module 103 can be configured to train images of the material of the floor with lightweight deep neural network offline model training, and input the pre-trained deep neural network offline model to the processor module 102. The processor module 102 can be used to identify a material of the floor around the robot cleaner, and a position of the floor where is located, and the distance between the floor and the robot cleaner 100 and the direction information between the floor and the robot cleaner 100, for example: the distance is ahead 1 meter with 30° orientation. The control module 104 (e.g., a micro controller MCU) coupled to the processor module 102 is configured to send a control signal to control the movement of the robot cleaner 100, includes: high speed and low suction motion mode, and low speed and high suction motion mode, and so on, but is not limited to those modes. The motion module 105 can be a driving wheel with driving motor (e.g., the universal wheels and the driving wheel), which can be configured to move according to the control signal, for example: high speed and low speed.

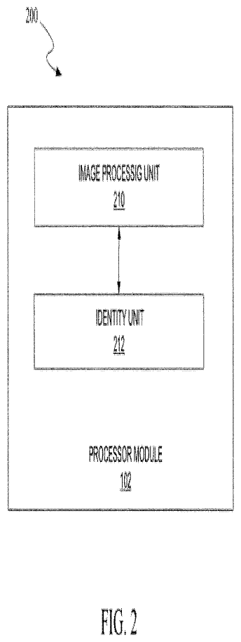

FIG. 2 illustrates a block diagram of a processor module 102 in the robot cleaner 100 with an adaptive control method based on the material of the floor according to one embodiment of the present invention. FIG. 2 can be understood in combination with the description of FIG. 1. As shown in FIG. 2, the processor module 102 includes a image processing unit 210 and an identify unit 212, wherein the image processing unit 210 is configured to calibrate distortion in the image sampled by the receive module 101, and the image is captured around the robot cleaner. Also, the image processing unit 210 further filters noises for the images, for example: Gauss filtering, the image is named as first image information. After pre-processing the image, i.e., be calibrated distortion and filtered noises, the pre-processed image named as second image information is inputted to the identify unit 212. And the second image information is used to perform lightweight deep neural network convolution calculation to obtain the material of the floor and the position information of the first image information, for example: the distance between the floor and the robot cleaner 100 and the direction information between the floor and the robot cleaner 100. The control module 104 send a control signal according to the material information of the floor and the position information of the floor.

In one embodiment, the control module 104 send a first control signal to instruct the motion module 105 to clean the floor with low speed and high suction motion mode when the material of the floor belongs to a first type, for example: soft floor, i.e., carpet. Instead, the control module 104 send a second control signal to instruct the motion module 105 to clean the floor with high speed and low suction motion mode when the material of the floor belongs to a second type, for example: hard floor, i.e., ceramic tile or Wooden floor.

Specifically, the identify unit 212 receives the second image information, for example: the pre-processed image, to perform lightweight deep neural network convolution calculation, and obtains types of material of the floor, and the position of the second image information.

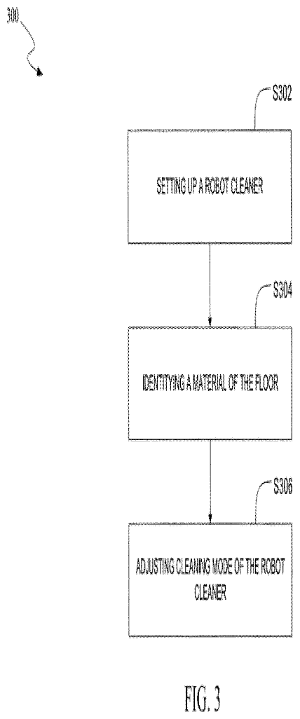

FIG. 3 illustrates a flowchart of a control method 300 for a robot cleaner 100 with an adaptive control method based on the material of the floor. FIG. 3 can be understood in combination with the description of FIGS. 1-2. As shown in FIG. 3, the operation method 300 for the robot cleaner 100 can includes:

Step S302: the user starts the robot cleaner 100. The robot cleaner 100 can clean the floor around the robot cleaner or a particular area. The robot cleaner 100 cleans the floor after being started.

Step S304: the robot cleaner 100 identifies the material of the floor around the robot cleaner 100, and the distance, direction between the floor and the robot cleaner 100.

Step S306: the robot cleaner 100 adjusts the cleaning mode according to the material of the floor. In one embodiment, the robot cleaner 100 cleans the floor with a first class cleaning mode when the material of the floor belongs to a first type; the robot cleaner 100 cleans the floor with a second class cleaning mode when the material of the floor belongs to a second type.

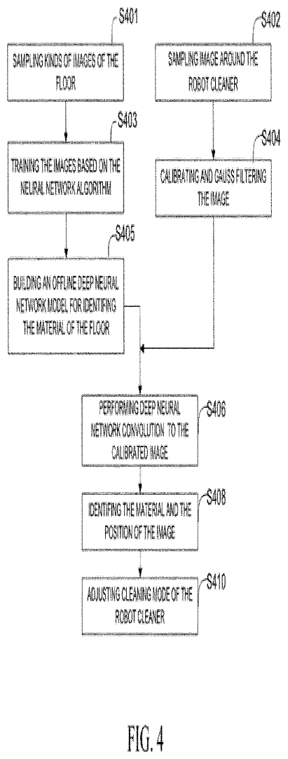

FIG. 4 illustrates a flowchart of a method 400 for identifying material around a robot cleaner with an adaptive control method based on the material of the floor. FIG. 4 can be understood in combination with the description of FIGS. 1-3. As shown in FIG. 4, the method 400 for identifying material around the robot cleaner 100 includes:

Step S402: the receive module 101 samples the image around the robot cleaner 100, the image as original image is sent to the processor module 102, in order to describe the image information clearly, the original image is also called a first image information. The first image information can be captured around the robot cleaner 100 or a particular area.

Step S404: after receiving the first image information, the image processing unit 210 in the processor module 102 calibrates distortion of the first image information, and filters the first image information with Gauss filtering. To avoid confusion, the pre-processed image is also named second image information after calibrating distortion and Gauss filtering for the first image information. The second image information is sent the identify unit 211 in the processor module 102 for using.

At the same time, the training module 103 in the robot cleaner 100 stores images database of the floor which includes many kinds of image, those images can be captured by the user or downloaded from the online. Specifically, the method further includes steps as below:

Step S401: the train module 103 samples kinds of images of the floor;

Step S403: the train module 103 trains kinds of images of the material of the floor with lightweight deep neural network offline model training;

S405: the train module 103 builds a deep neural network model for identifying the material of the floor;

S406: the identify unit 212 in the processor module 102 imports offline deep neural network model, and inputs the second image information as input image, and perform deep network convolution calculation to the second image information;

S408: the identify unit obtains the material information of the floor and position information of the second image information, for example: the material of the floor is soft material or hard material, and the position information includes the distance and direction between the floor and the robot cleaner 100;

S410: the control module 104 determines cleaning mode according to the material information of the floor and adjusts the cleaning mode. In one embodiment, the control module 104 in the robot cleaner 100 send a first control signal to instruct the motion module 105 to clean as first cleaning mode when the material of the floor is a first type material, for example: hard material, and the first cleaning mode is high speed and low suction motion mode. The control module 104 in the robot cleaner 100 send a second control signal to instruct the motion module 105 to clean as second cleaning mode when the material of the floor is a second type material, for example: soft material, and the second cleaning mode is low speed and high suction motion mode. It will be understood that the cleaning modes are not intended to limit the invention to these embodiments, and the cleaning mode can be set by the user.

Advantageously, in the present invention, the robot cleaner with an adaptive control method based on the material of the floor and robot cleaner can provide better home service than traditional robot cleaner.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A robot cleaner with an adaptive control method based on a material of a floor, comprising:
a receive module, configured to receive a first image information around said robot cleaner;
a processor module, coupled to said receive module, configured to identify a material of a floor around said robot cleaner, and a position of said first image information according to said first image information;
a control module, coupled to said processor module, configured to send a control signal to control movement of the robot cleaner according to the material of the floor which is identified by said processor module and the position of said first image information; and
a motion module, configured to control operation of a motor to drive the robot cleaner with a cleaning mode according to said control signal.

2. The robot cleaner according to claim 1, wherein the robot cleaner further includes a training module, configured to train kinds of images of the material of the floor with lightweight deep neural network offline model training, and build a deep neural network model for identifying the material of the floor.

3. The robot cleaner according to claim 1, wherein said processor module further includes an image processing unit, is configured to pre-process the first image information, and obtain second image information after calibrating distortion and Gauss filtering for the first image information.

4. The robot cleaner according to claim 1, wherein the processor module further includes an identify unit, is configured to receive the second image information, and input said second image information to the deep neural network model to perform lightweight deep neural network convolution calculation to obtain the material of the floor and the position information of the first image information.

5. The robot cleaner according to claim 4, wherein the position information of the first image information includes distance and direction.

6. The robot cleaner according to claim 4, wherein the control module send a first control signal to instruct the motion module to work with high speed and low suction motion mode when the material of the floor is hard material.

7. The robot cleaner according to claim 4, wherein the control module send a second control signal to instruct the motion module to work with low speed and high suction motion mode when the material of the floor is soft material.

8. The robot cleaner according to claim 1, wherein the clean mode of the motion module includes high speed motion mode, low suction motion mode, low speed motion mode and high suction motion mode.

9. A method for controlling a robot cleaner with an adaptive control method based on a material of a floor, comprising:
sampling first image information around the robot cleaner;
identifying a material of the floor around said robot cleaner, and a position of said first image information according to said first image information
sending a control signal to control movement of the robot cleaner according to the material of the floor which is identified and the position of said first image information; and
moving with a cleaning mode according to the control signal.

10. The control method for a robot cleaner according to claim 9, comprising:
training on kinds of images of the material of the floor with lightweight deep neural network offline model training, and build a deep neural network model for identifying the material of the floor;

11. The control method for a robot cleaner according to claim 9, comprising:
pre-processing for the first image information to obtain second image information after calibrating distortion and Gauss filtering for the first image information

12. The control method for a robot cleaner according to claim 11, comprising:
inputting the second image information to the deep neural network model, and performing lightweight deep neural network convolution calculation to obtain the material of the floor and the position information of the first image information.

13. The control method for a robot cleaner according to claim 12, comprising: wherein the position information of the first image information includes distance and direction.

14. The control method for a robot cleaner according to claim 9, comprising: sending a first control signal to instruct the motion module to work with high speed and low suction motion mode when the material of the floor is hard material.

15. The control method for a robot cleaner according to claim 9, comprising: sending a second control signal to instruct the motion module to work with low speed and high suction motion mode when the material of the floor is soft material.
